(19) United States
(12) Patent Application Publication
(10) Pub. No.: US 2022/0176832 A1
(43) Pub. Date: Jun. 9, 2022

(54) 219-0150 METHOD FOR ESTIMATING THE NEED FOR ELECTRICAL ENERGY OF A MOTOR VEHICLE FOR A PREDEFINABLE TRAVEL ROUTE

(71) Applicant: Ford Global Technologies, LLC, Dearborn, MI (US)

(72) Inventors: Markus Espig, Aachen (DE); David van Bebber, Aachen (DE)

(21) Appl. No.: 17/457,406

(22) Filed: Dec. 2, 2021

(30) Foreign Application Priority Data
Dec. 4, 2020 (DE) 10 2020 007 403.0

(51) Int. Cl. B60L 15/20; B60W 20/10

(52) U.S. Cl. CPC B60L 15/2045; B60W 2552/40; B60W 2510/244; B60L 2240/423; B60L 2240/26; B60L 2240/12; B60L 2240/54; B60L 2240/14; B60L 2240/642; B60L 2240/647; B60W 2530/10; B60W 2530/16; B60W 2520/105; B60W 2520/125; B60W 2552/15; B60W 2520/12; B60W 2510/0666; B60W 2510/085; B60W 20/10

(57) ABSTRACT

Methods and systems are provided for a vehicle system. In one example, a method may include ascertaining a functional relationship between the driving resistance and the velocity vᵥₑₕ of a motor vehicle comprising an electrical machine as a torque source for the drive and a storage device for electrical energy.

### CROSS REFERENCE TO RELATED APPLICATIONS

The present application claims priority to German Patent Application No. 10 2020 007 403.0, entitled “219-0150 Road Load Estimator for battery electric vehicles”, and filed on Dec. 4, 2020. The entire contents of the above-listed application is hereby incorporated by reference for all purposes.

### FIELD

The present description relates generally to a method for ascertaining a functional relationship between the driving resistance and the velocity vᵥₑₕ of a motor vehicle comprising an electrical machine as a torque source for the drive and a storage device for electrical energy.

### BACKGROUND/SUMMARY

Efforts are continuously made in the development of drives for vehicles to minimize the fuel consumption. Moreover, a reduction of the pollutant emissions is sought in order to be able to comply with future limiting values for pollutant emissions.

According to the prior art, electrical drives are therefore being used more ever more frequently in vehicles, regularly in combination with an internal combustion engine as a hybrid drive.

The electric drive doubtlessly has its justification or its advantages as an emission-free drive in urban traffic. However, there are further relevant reasons for the use of electrical drives, for example, the reduction of the drive noise of a vehicle.

Among other things, the precise prediction of the need for or consumption of electrical energy for an upcoming journey is problematic in the use of electrical drives. However, this is an important or indispensable condition for planning a journey, in order to ensure that the electrical energy available in the storage device is sufficient to meet the need. The precise prediction of the energy need is also required, however, to be able to compare different driving routes, i.e., travel routes, and to utilize the energy available in the storage device efficiently or as much as possible before the storage device is filled again.

Different concepts are used according to the prior art for the prediction of the need for electrical energy. The fleet consumption, the average consumption during specific driving cycles, or the consumption of the respective vehicle in the past can be used as the basis to estimate the energy need for an upcoming journey.

The energy need for an upcoming journey may also be estimated by computer by means of simulation models. In this case, vehicle-specific data, for example, the mass mᵥₑₕ, the rolling resistance coefficient fᵣₒₗₗ, the air resistance coefficient c_{w}, and/or the area A of the motor vehicle are predefined.

So-called coasting experiments are also taken into consideration according to the prior art, in which the vehicle coasts on a level, i.e., not inclined test track starting from a predefinable velocity and with interrupted drivetrain, wherein the deceleration is detected metrologically.

The procedures according to the prior art have the disadvantage that the vehicle-specific data are actually not constants, but rather are subjected to greater or lesser changes and this is not taken into consideration.

In particular, the mass mᵥₑₕ of the motor vehicle is subject to strong variations and has significant influence on the energy consumption of the vehicle. The area A of the motor vehicle relevant for the air resistance can also vary, specifically in dependence on whether or not a roof luggage rack is used.

In the context of the present disclosure, the mass mᵥₑₕ of the motor vehicle is the total mass, which comprises the vehicle empty mass, the cargo, and the mass of the occupants.

The rolling resistance coefficient fᵣₒₗₗ changes for example with the tire pressure, but also with the roadway condition, wherein a dry and a wet roadway surface can result in significantly different rolling resistance coefficients.

Against the background of these statements, it is the object of the present disclosure to disclose a method for ascertaining a functional relationship between the driving resistance and the velocity vᵥₑₕ of a motor vehicle comprising an electrical machine as a torque source for the drive and a storage device for electrical energy, in order to be able to estimate the need for electrical energy for a predefinable travel route more accurately than is possible according to the prior art.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows the forces acting on the motor vehicle during travel and the equations used in the scope of the method.

FIG. 2 shows a diagram illustrating forces acting on the motor vehicle during travel and equations used in the scope of the method.

FIG. 3 shows a schematic of a hybrid vehicle.

FIG. 4 shows a method for executing a road load estimator.

### DETAILED DESCRIPTION

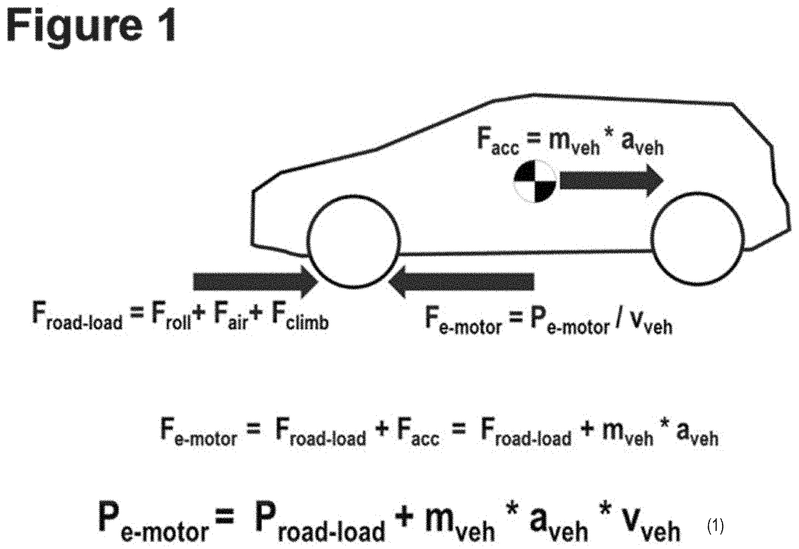

The following description relates to systems and methods for estimating a vehicle road load for a current vehicle state. Conditions for quantifying a vehicle road load are illustrated in FIG. 1. Preconditions for estimating the vehicle road load may include a vehicle mass, vehicle velocity, road gradient, and wind resistance. In one example, one or more assumptions may be executed via a road load estimator, as will be described herein. Additionally or alternatively, ranges or known values may be predefined in the road load estimator for one or more vehicle specific coefficients or parameters. As another example, additionally or alternatively, external information may be retrieved and used in the road load estimator. For example, geographical maps or data from an internal vehicle inclination sensor may be used to offset an effect of road gradients (e.g., climbing resistance. As another example, weather data may be used to offset an effect of wind (e.g., air resistance), rain, and/or snow (e.g., rolling resistance). In this way, current vehicle weight, rolling resistance, and air resistance. In this way, the load may be estimated during a plurality of operating parameters, without intrusively modifying operating parameters, based on a vehicle speed and e-motor power output.

In one example, a method for ascertaining a functional relationship between the driving resistance and the velocity, vᵥₑₕ, of a motor vehicle comprising an electrical machine as a torque source for the drive of the motor vehicle and a storage device for electrical energy, in which an equation having n unknowns and m available knowns is used for the driving resistance, during the operation of the motor vehicle i equations having i≥n are set up at different times t, for which the m available knowns are provided, so that a not underdetermined equation system having i equations is provided, and the functional relationship between the driving resistance and the velocity vᵥₑₕ of the motor vehicle is ascertained using the equation system.

According to the method according to the disclosure, an equation having n unknowns and m available knowns is used for the driving resistance. To obtain a determined or overdetermined equation system having i equations, during the operation or the journey of the motor vehicle, the equation is set up i times at different times tᵢ, wherein the following applies: i≥n. The m available knowns are provided for the i equations, each at the time tᵢ.

Using the equation system, the functional relationship between the driving resistance and the velocity vᵥₑₕ of the motor vehicle may be ascertained.

The functional relationship between the driving resistance and the velocity vᵥₑₕ of the motor vehicle is used as the basis for the estimation of the need for electrical energy for a predefinable travel route. The need for electrical energy can be compared to the electrical energy available in the storage device.

Method variants may further include where i is significantly greater than n where i>>n. While the equation can have, for example, n≈3 to 8 unknowns, the value of i is preferably at i≈1000 to 4000. The greater i, the more accurate is the prediction of the energy need.

The method may consider the circumstance that the energy need can vary strongly with different boundary conditions.

For example, in the event of rain, the rolling resistance coefficient fᵣₒₗₗ may change significantly and in a relevant manner. According to the disclosure, the rolling resistance coefficient fᵣₒₗₗ may be considered as one of n unknowns and thus as a variable. The mass mᵥₑₕ of the motor vehicle has a significant influence on the energy consumption of the vehicle and can be taken into consideration according to the method according to the disclosure as one of n unknowns and thus as a variable in the equation used.

A plurality of variables can be taken into consideration as unknowns and thus as a variable in the equation in the scope of the method according to the disclosure. Other examples are also mentioned hereinafter.

An information unit can be provided to manage the m available knowns. The data can be of greatly differing type and origin and can relate, for example, to the vehicle, the drivetrain, the antilock braking system, a velocity sensor, an acceleration sensor, an inclination sensor, the storage device for electrical energy, the ambient conditions, the driver himself, or data of other systems, such as the data of a navigation system.

The disclosure further includes support for a method for ascertaining a functional relationship between the driving resistance and the velocity vᵥₑₕ of a motor vehicle comprising an electrical machine as a torque source for the drive and a storage device for electrical energy, in order to be able to estimate the need for electrical energy for a predefinable travel route more accurately than is possible according to the prior art.

Embodiments of the method may further include where the functional relationship between the driving resistance power P_{road-load} and the velocity vᵥₑₕ of the motor vehicle is ascertained. In the present case, the driving resistance power P_{road-load} is used as the driving resistance.

Method variants may include the equation 1 below

$${P}_{e \text{-} motor} = {P}_{road \text{-} load} + {{m}_{veh}}^{*} {{a}_{veh}}^{*} {v}_{veh} \qquad ( 1 )$$

Pₑ₋ₘₒₜₒᵣ denotes a drive power of the electrical machine, mᵥₑₕ denotes a mass of the motor vehicle, and aᵥₑₕ denotes an acceleration of the motor vehicle. Pₑ₋ₘₒₜₒᵣ, aᵥₑₕ, and vᵥₑₕ, may be available inputs (e.g., known values) provided from a motor sensor, an acceleration sensor, and an anti-lock brake (ABS) sensor.

Neglecting the losses in the drivetrain, the drive power at the wheel of the motor vehicle can be equated to the output power of the electrical machine. Losses in the drivetrain of the motor vehicle can also be taken into consideration, however, by way of an efficiency f of the drivetrain or a power loss Pₗₒₛₛ for example.

Embodiments of the method may further include the equation 2 below for the driving resistance power P_{road-load}.

$${P}_{road \text{-} load} = {{F}_{road \text{-} load}}^{*} {v}_{veh} \qquad ( 2 )$$

F_{road-load} denotes a driving resistance force, which is based on equation 3 below.

$${F}_{road \text{-} load} = {F}_{roll} + {F}_{air} + {F}_{climb} \qquad ( 3 )$$

Fᵣₒₗₗ denotes a rolling resistance force, Fₐᵢᵣ denotes an air resistance force, and F_{climb} denotes a force acting on vehicle speed as a result of an uphill slope or downhill slope.

Embodiments of the method may further include where the rolling resistance force Fᵣₒₗₗ is dependent on a rolling resistance coefficient fᵣₒₗₗ.

Embodiments of the method may include where the air resistance force Fₐᵢᵣ is dependent on an air resistance coefficient c_{w} and an area A of the motor vehicle perpendicular to the velocity vᵥₑₕ of the motor vehicle.

Embodiments of the method may include where the force F_{climb} is dependent on a roadway inclination α_{road}.

However, for ascertaining the driving resistance force embodiments of the method may include where equation 4 is used instead of or in combination with equation 3 for the driving resistance force F_{road-load}.

$${F}_{road \text{-} load} = {f}_{0} + {f}_{1} * {v}_{veh} + {{f}_{2}}^{*} {{v}_{veh}}^{2} \qquad ( 4 )$$

In equation 4, f₀, f₁, and f₂ denote vehicle-specific coefficients.

Embodiments of the method may include where one or more of the following variables are used as unknowns in the equations 1-4, the mass mᵥₑₕ of the motor vehicle, the rolling resistance force Fᵣₒₗₗ, the rolling resistance coefficient fᵣₒₗₗ, the air resistance force Fₐᵢᵣ, the air resistance coefficient c_{w}, the area A of the motor vehicle, the force F_{climb}, the roadway inclination α_{road}, the vehicle-specific coefficient f₀, the vehicle-specific coefficient f₁, and the vehicle-specific coefficient f₂.

The use as unknowns takes the circumstance into consideration that the respective variable is variable, i.e., can change.

Nonetheless, each of the above-mentioned variables can also be predefined as a constant value, which is equal for all i equations. Additionally or alternatively, each of the variables may be equal to an average determined over time.

Embodiments of the method may include where one or more of the following variables are used as available knowns in the equation the drive power Pₑ₋ₘₒₜₒᵣ of the electrical machine, the velocity vᵥₑₕ of the motor vehicle, and the acceleration aᵥₑₕ of the motor vehicle.

The instantaneous drive power Pₑ₋ₘₒₜₒᵣ of the electrical machine may be known and is available in an information unit or central data line.

Embodiments of the method may include where the velocity vᵥₑₕ of the motor vehicle is metrologically detected via sensors.

Embodiments of the method may include where the acceleration aᵥₑₕ of the motor vehicle is metrologically detected via sensors.

However, embodiments of the method may include where the acceleration aᵥₑₕ of the motor vehicle is ascertained by computer from a change of the velocity vᵥₑₕ of the motor vehicle.

Embodiments of the method may include where values are predefined for one or more of the following variables including the mass mᵥₑₕ of the motor vehicle, the rolling resistance force Fᵣₒₗₗ, the rolling resistance coefficient fᵣₒₗₗ, the air resistance force Fₐᵢᵣ, the air resistance coefficient c_{w}, the area A of the motor vehicle, the force F_{climb}, the roadway inclination α_{road}, the vehicle-specific coefficient f₀, the vehicle-specific coefficient f₁, and the vehicle-specific coefficient f₂.

Embodiments of the method may include where the force F_{climb}, and/or the roadway inclination α_{road} are determined via a sensor or geographic data are used. Geographic data can be the data of a navigation system.

An uphill slope or a downhill slope of the presently traveled roadway can be data which originate from a driver information system or a navigation system and provide details about whether a mountain, a hill, or a valley bottom is being driven through or is to be driven through. The latter are data which are taken into consideration in the scope of so-called predictive driving.

With unknown roadway inclination α_{road}, in the individual case, namely with continuously changing road inclination α_{road}, a new, additional unknown can result for each measurement point, so that the number i of the equations always remains less than the number of the unknowns. I.e., the equation system that is set up would always remain underdetermined.

With the assumption that the roadway inclination α_{road} only changes slowly, according to one method variant, a constant inclination can be presumed for at least two successive measurement points, as a consequence of which the number of the unknowns is reduced enough that the equation system is solvable again. Inaccuracies or deviations which result for rare rapid changes of the inclination using this simplified assumption can be countered or attenuated using so-called nonlinear regression methods by a lower weighting of outliers of the road inclination α_{road}.

Embodiments of the method may include where meteorological data are used for the specification of one or more of the following variables including the rolling resistance force Fᵣₒₗₗ, the rolling resistance coefficient fᵣₒₗₗ, the air resistance force Fₐᵢᵣ, and the air resistance coefficient c_{w}. Meteorological data may correspond to data sent via a weather service.

Embodiments of the method may include where the ascertained functional relationship between the driving resistance and the velocity vᵥₑₕ of the motor vehicle is used to estimate the need for electrical energy for a predefinable travel route.

Embodiments of the method may include where the need for electrical energy is compared to the electrical energy available in the storage device.

Data about the state of charge of the energy storage device for electrical energy can be managed in an information unit and provided if needed.

For example, an accumulator or a capacitor can be used as the energy storage device, which can also absorb and store excess power provided by an internal combustion engine, which is not demanded, if the electrical machine is used not as a drive, but as a generator. In this way, energy may also be reclaimed and stored in coasting operation.

In principle, an energy storage device for electrical energy can also be a hydrogen tank in combination with a fuel cell. This combination also provides electrical energy for the electrical machine if needed and stores electrical energy in the form of available hydrogen.

The method according to the disclosure can also be applied or transferred in an equivalent manner to conventional drives. I.e., for example, it can be used in a motor vehicle having an internal combustion engine as the sole or additional torque source and a fuel tank as a fuel storage device for fossil energy carriers.

FIG. 1 schematically shows the forces acting on the motor vehicle during travel and the equations used in the scope of the method.

During travel, the drive force Fₑ₋ₘₒₜₒᵣ of the electrical machine, the driving resistance force F_{road-load}, which opposes the drive force, and the acceleration force F_{acc} act on the motor vehicle.

The driving resistance force F_{road-load} is composed of the rolling resistance force Fᵣₒₗₗ, the air resistance force Fₐᵢᵣ, and the force F_{climb} acting on the motor vehicle in a decelerating or accelerating manner as a result of an uphill slope or downhill slope.

For the acceleration force F_{acc}, the following applies: F_{acc}=mᵥₑₕ*aᵥₑₕ.

If rotational accelerations are considered, the following applies: F_{acc}=(eᵢ*m_{veh,leer}+m_{add})*aᵥₑₕ, wherein eᵢ is a factor, m_{veh,leer} denotes the vehicle empty mass, and m_{add} denotes the cargo including occupants.

In the present case, the equation (1) may be used, wherein the drive power of the electrical machine Pₑ₋ₘₒₜₒᵣ, the velocity vᵥₑₕ of the motor vehicle, and the acceleration aᵥₑₕ of the motor vehicle are known in the present case, i.e., are available knowns.

The mass mᵥₑₕ of the motor vehicle and the coefficients and variables intrinsic to the driving resistance force F_{road-load} can be entered as unknowns in the equation and taken into consideration as variables.

Using the equation system, the functional relationship between the driving resistance power P_{road-load} and the velocity vᵥₑₕ of the motor vehicle is ascertained.

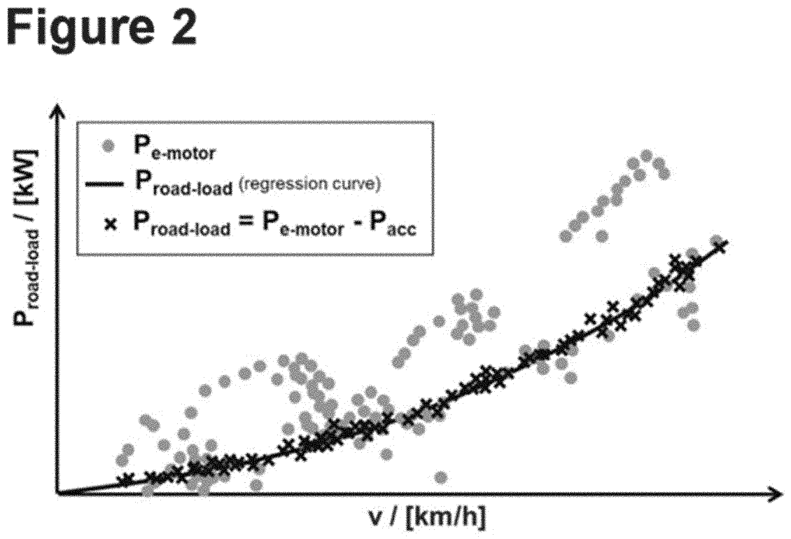

FIG. 2 shows in a diagram this functional relationship between the driving resistance power P_{road-load} and the velocity vᵥₑₕ of the motor vehicle, wherein the velocity vᵥₑₕ of the motor vehicle is plotted on the abscissa and the driving resistance power P_{road-load} is plotted on the ordinate.

The circles illustrate the drive power Pₑ₋ₘₒₜₒᵣ and the crosses illustrate the driving resistance power P_{road-load}. The solid curve is the function P_{road-load}=f (vᵥₑₕ) ascertained by means of regression.

This functional relationship is now used to estimate the need for energy for a predefinable travel route. The energy consumed may correspond to electrical energy, fuel energy, or other forms of energy. The mass mᵥₑₕ of the motor vehicle is again taken into consideration.

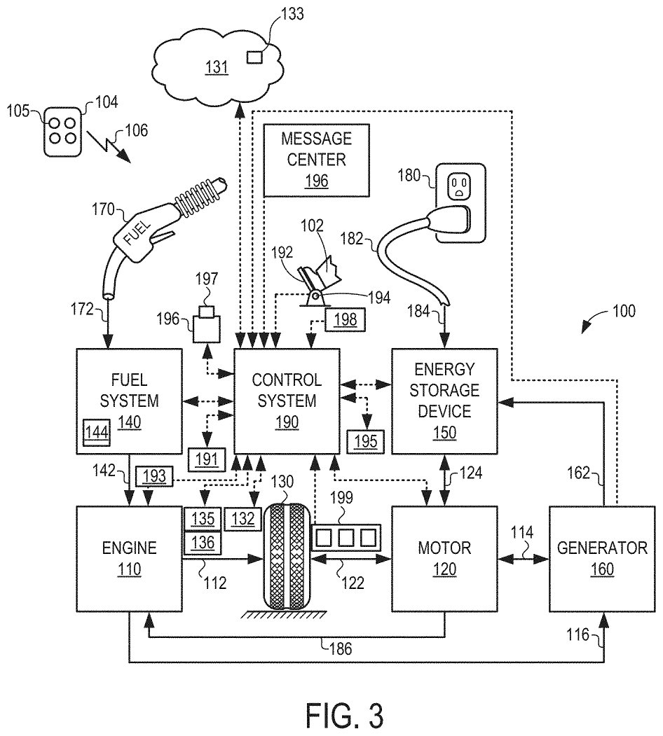

FIG. 3 illustrates an example vehicle propulsion system 100. Vehicle propulsion system 100 includes a fuel burning engine 110 and a motor 120. As a non-limiting example, engine 110 comprises an internal combustion engine and motor 120 comprises an electric motor. Motor 120 may be configured to utilize or consume a different energy source than engine 110. For example, engine 110 may consume a liquid fuel (e.g., gasoline) to produce an engine output while motor 120 may consume electrical energy to produce a motor output. As such, a vehicle with propulsion system 100 may be referred to as a hybrid electric vehicle (HEV).

Vehicle propulsion system 100 may utilize a variety of different operational modes depending on operating conditions encountered by the vehicle propulsion system. Some of these modes may enable engine 110 to be maintained in an off state (i.e., set to a deactivated state) where combustion of fuel at the engine is discontinued. For example, under select operating conditions, motor 120 may propel the vehicle via drive wheel 130 as indicated by arrow 122 while engine 110 is deactivated, which may herein be referred to as an electric-only operation.

During other operating conditions, engine 110 may be set to a deactivated state (as described above) while motor 120 may be operated to charge energy storage device 150. For example, motor 120 may receive wheel torque from drive wheel 130 as indicated by arrow 122 where the motor may convert the kinetic energy of the vehicle to electrical energy for storage at energy storage device 150 as indicated by arrow 124. This operation may be referred to as regenerative braking of the vehicle. Thus, motor 120 can provide a generator function in some examples. However, in other examples, generator 160 may instead receive wheel torque from drive wheel 130, where the generator may convert the kinetic energy of the vehicle to electrical energy for storage at energy storage device 150 as indicated by arrow 162. In some examples, the engine 110 may deactivate during regenerative braking and traction at the drive wheel 130 may be negative, such that the motor 120 may spin in reverse and recharge the energy storage device 150. Thus, regenerative braking may be distinguished from an electric-only operation, where the motor 120 may provide positive traction at the drive wheel 130, thereby decreasing a SOC of the energy storage device 150 while the engine 110 is deactivated.

During still other operating conditions, engine 110 may be operated by combusting fuel received from fuel system 140 as indicated by arrow 142. For example, engine 110 may be operated to propel the vehicle via drive wheel 130 as indicated by arrow 112 while motor 120 is deactivated, such as during a charge-sustaining operation. During other operating conditions, both engine 110 and motor 120 may each be operated to propel the vehicle via drive wheel 130 as indicated by arrows 112 and 122, respectively. A configuration where both the engine and the motor may selectively propel the vehicle may be referred to as a parallel type vehicle propulsion system or a hybrid propulsion. Note that in some examples, motor 120 may propel the vehicle via a first set of drive wheels and engine 110 may propel the vehicle via a second set of drive wheels.

In other examples, vehicle propulsion system 100 may be configured as a series type vehicle propulsion system, whereby the engine does not directly propel the drive wheels. Rather, engine 110 may be operated by power motor 120, which may in turn propel the vehicle via drive wheel 130 as indicated by arrow 122. For example, during select operating conditions, engine 110 may drive generator 160 as indicated by arrow 116, which may in turn supply electrical energy to one or more of motor 120 as indicated by arrow 114 or energy storage device 150 as indicated by arrow 162. As another example, engine 110 may be operated to drive motor 120 which may in turn provide a generator function to convert the engine output to electrical energy, where the electrical energy may be stored at energy storage device 150 for later use by the motor.

In still other examples, motor 120 may be configured to rotate engine unfueled in a forward (e.g. default orientation) or reverse orientation, using energy provided via energy storage device 150, exemplified by arrow 186.

Fuel system 140 may include one or more fuel storage tanks 144 for storing fuel on-board the vehicle. For example, fuel tank 144 may store one or more liquid fuels, including but not limited to: gasoline, diesel, and alcohol fuels. In some examples, the fuel may be stored on-board the vehicle as a blend of two or more different fuels. For example, fuel tank 144 may be configured to store a blend of diesel and biodiesel, gasoline and ethanol (e.g., E10, E85, etc.) or a blend of gasoline and methanol (e.g., M10, M85, etc.), whereby these fuels or fuel blends may be delivered to engine 110 as indicated by arrow 142. Still other suitable fuels or fuel blends may be supplied to engine 110, where they may be combusted at the engine to produce an engine output. The engine output may be utilized to propel the vehicle as indicated by arrow 112 or to recharge energy storage device 150 via motor 120 or generator 160.

In some examples, energy storage device 150 may be configured to store electrical energy that may be supplied to other electrical loads residing on-board the vehicle (other than the motor), including cabin heating and air conditioning, engine starting, headlights, cabin audio and video systems, etc. As a non-limiting example, energy storage device 150 may include one or more batteries and/or capacitors. In some examples, increasing the electrical energy supplied from the energy storage device 150 may decrease an electric-only operation range, as will be described in greater detail below.

Control system 190 may communicate with one or more of engine 110, motor 120, fuel system 140, energy storage device 150, and generator 160. In some examples, control system 190 may be used as a controller, a processor, or other computing device. Control system 190 may receive sensory feedback information from one or more of engine 110, motor 120, fuel system 140, energy storage device 150, and generator 160. Further, control system 190 may send control signals to one or more of engine 110, motor 120, fuel system 140, energy storage device 150, and generator 160 responsive to this sensory feedback. In some examples, control system 190 may receive an indication of an operator requested output of the vehicle propulsion system from a vehicle operator 102. For example, control system 190 may receive sensory feedback from pedal position sensor 194 which communicates with pedal 192. Pedal 192 may refer schematically to a brake pedal and/or an accelerator pedal. Furthermore, in some examples control system 190 may be in communication with a remote engine start receiver 195 (or transceiver) that receives wireless signals 106 from a key fob 104 having a remote start button 105. In other examples (not shown), a remote engine start may be initiated via a cellular telephone, or smartphone based system where a user's cellular telephone sends data to a server and the server communicates with the vehicle to start the engine.

In some examples, additionally or alternatively, the vehicle propulsion system 100 may be configured to operate autonomously (e.g., without a human vehicle operator). As such, the control system 190 may determine one or more desired operating engine conditions based on estimated current driving conditions.

Energy storage device 150 may periodically receive electrical energy from a power source 180 residing external to the vehicle (e.g., not part of the vehicle) as indicated by arrow 184. As a non-limiting example, vehicle propulsion system 100 may be configured as a plug-in hybrid electric vehicle (HEV), whereby electrical energy may be supplied to energy storage device 150 from power source 180 via an electrical energy transmission cable 182. During a recharging operation of energy storage device 150 from power source 180, electrical transmission cable 182 may electrically couple energy storage device 150 and power source 180. While the vehicle propulsion system is operated to propel the vehicle, electrical transmission cable 182 may disconnect between power source 180 and energy storage device 150. Control system 190 may identify and/or control the amount of electrical energy stored at the energy storage device, which may be referred to as the state of charge (SOC).

In other examples, electrical transmission cable 182 may be omitted, where electrical energy may be received wirelessly at energy storage device 150 from power source 180. For example, energy storage device 150 may receive electrical energy from power source 180 via one or more of electromagnetic induction, radio waves, and electromagnetic resonance. As such, it should be appreciated that any suitable approach may be used for recharging energy storage device 150 from a power source that does not comprise part of the vehicle. In this way, motor 120 may propel the vehicle by utilizing an energy source other than the fuel utilized by engine 110.

Fuel system 140 may periodically receive fuel from a fuel source residing external to the vehicle. As a non-limiting example, vehicle propulsion system 100 may be refueled by receiving fuel via a fuel dispensing device 170 as indicated by arrow 172. In some examples, fuel tank 144 may be configured to store the fuel received from fuel dispensing device 170 until it is supplied to engine 110 for combustion. In some examples, control system 190 may receive an indication of the level of fuel stored at fuel tank 144 via a fuel level sensor. The level of fuel stored at fuel tank 144 (e.g., as identified by the fuel level sensor) may be communicated to the vehicle operator, for example, via a fuel gauge or indication in a vehicle instrument panel 196.

The vehicle propulsion system 100 may also include an ambient temperature/humidity sensor 198, and a roll stability control sensor, such as a lateral and/or longitudinal and/or yaw rate sensor(s) 199. The vehicle instrument panel 196 may include indicator light(s) and/or a text-based display in which messages are displayed to an operator. The vehicle instrument panel 196 may also include various input portions for receiving an operator input, such as buttons, touch screens, voice input/recognition, etc. For example, the vehicle instrument panel 196 may include a refueling button 197 which may be manually actuated or pressed by a vehicle operator to initiate refueling. For example, as described in more detail below, in response to the vehicle operator actuating refueling button 197, a fuel tank in the vehicle may be depressurized so that refueling may be performed.

Control system 190 may be communicatively coupled to other vehicles or infrastructures using appropriate communications technology, as is known in the art. For example, control system 190 may be coupled to other vehicles or infrastructures via a wireless network 131 (e.g., a central network), which may comprise Wi-Fi, Bluetooth, a type of cellular service, a wireless data transfer protocol, and so on. Control system 190 may broadcast (and receive) information regarding vehicle data, vehicle diagnostics, traffic conditions, vehicle location information, vehicle operating procedures, etc., via vehicle-to-vehicle (V2V), vehicle-to-infrastructure-to-vehicle (V2I2V), vehicle-to-infrastructure (V2I), and/or vehicle-to-everything (V2X) technology. The communication and the information exchanged between vehicles can be either directly between vehicles, or can be multi-hop. In some examples, longer range communications (e.g. WiMax) may be used in place of, or in conjunction with, V2V, or V2I2V, to extend the coverage area by a few miles. In still other examples, vehicle control system 190 may be communicatively coupled to other vehicles or infrastructures via the wireless network 131 and the internet (e.g. cloud), as is commonly known in the art. One example of a V2V communication device may include dedicated-short-range-communication (DSRC) network which may allow vehicles within a threshold proximity (e.g., 5,000 feet) to communicate (e.g., transfer information) free of an internet connection

The wireless network 131 may include one or more computing systems (e.g., servers) including memory and one or more processors, such as processor 133. The memory may be configured to store various anomaly detection/remaining useful life determination models, as well as various data provided thereto, including vehicle operational/sensor data obtained from multiple vehicles. The processor may execute the instructions stored in memory in order to enter the vehicle operational/sensor data into the various models, adjust autonomous driving thresholds based on the output of the models, sort the models, etc., as described below.

In some examples, the wireless network 131 includes V2X functionality that may work in tandem with remote vehicles (RVs) and infrastructure components, such as road side units (RSUs). The RVs and the RSUs may exchange defined messages, creating a connected vehicle communication infrastructure to enhance vehicle performance. The wireless network 131 may utilize radio technology, such as DSRC or cellular based V2X (e.g., CV2X). As the messages are broadcasted, vehicles in communication with the network may receive one or more of the transmitted messages. The wireless network 131 may be in further communication with mobile devices and other wireless communication devices to enhance a driving experience.

Vehicle propulsion system 100 may also include an on-board navigation system 132 (for example, a Global Positioning System) that an operator of the vehicle may interact with. The navigation system 132 may include one or more location sensors for assisting in estimating vehicle speed, vehicle altitude, vehicle position/location, etc. This information may be used to infer engine operating parameters, such as local barometric pressure. As discussed above, control system 190 may further be configured to receive information via the internet or other communication networks. Information received from the GPS may be cross-referenced to information available via the internet to determine local weather conditions, local vehicle regulations, etc.

In some examples, vehicle propulsion system 100 may include one or more onboard cameras 135. Onboard cameras 135 may communicate photos and/or video images to control system 190, for example. Onboard cameras may in some examples be utilized to record images within a predetermined radius of the vehicle, for example. The onboard cameras 135 may be arranged on an exterior surface of the vehicle so that an area surrounding and/or adjacent to the vehicle may be visualized.

In some examples, the vehicle propulsion system 100 may be an all-electric vehicle system wherein the engine, the fuel tank, and other fuel based components are omitted.

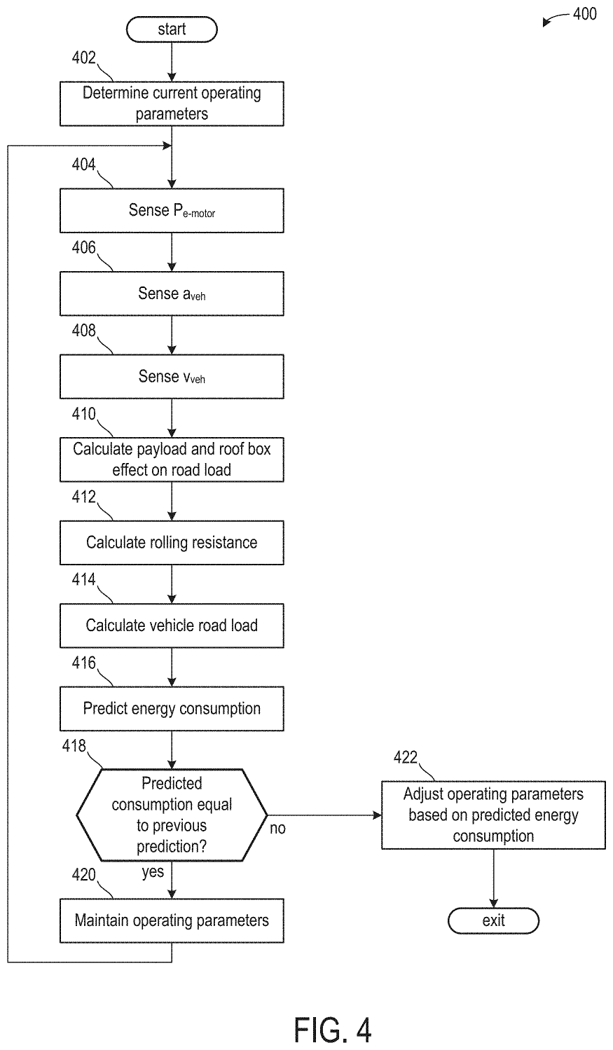

Turning now to FIG. 4, it shows a method 400 for executing the road load estimator algorithm of FIG. 1. Instructions for carrying out method 400 may be executed by a controller based on computer-readable instructions stored on a memory of the controller and in conjunction with signals received from sensors of the engine system, such as the sensors described above with reference to FIG. 1. The controller may employ engine actuators of the engine system to adjust engine operation, according to the methods described below.

The method 400 may begin at 402, which includes determining current operating parameters. Current operating parameters may include a vehicle speed, a vehicle location, weather, and the like.

At 404, the method 400 may include sensing Pₑ₋ₘₒₜₒᵣ. Pₑ₋ₘₒₜₒᵣ may be equal to a drive power of the electrical machine. In one example, the electrical machine is the motor 120 of FIG. 3. The drive power may be sensed via a controller of the vehicle, which may be in proportion to a pedal position or a speed limit of an area in which the vehicle is operating.

At 406, the method 400 may include sensing aᵥₑₕ. aᵥₑₕ may be equal to an acceleration of the motor vehicle. The acceleration may be a positive value if the vehicle speed is increasing or a negative value if the vehicle speed is decreasing. The acceleration may be sensed via an acceleration sensor.

At 408, the method 400 may include sensing vᵥₑₕ. vᵥₑₕ may be equal to a velocity of the vehicle. The velocity vᵥₑₕ of the motor vehicle is metrologically detected via an ABS sensor.

At 410, the method 400 may include calculating a payload, m_{add}, and a roof box effect, c_{w}*A, on the road load. Air resistance force Fₐᵢᵣ is dependent on an air resistance coefficient c_{w} and an area A of the motor vehicle perpendicular to the velocity vᵥₑₕ of the motor vehicle. Thus, the roof box effect is defined as the air resistance experienced across an area of the vehicle, which may be magnified depending on modified from factory values via attachments fixed to the vehicle.

At 412, the method 400 may include calculating the rolling resistance, Fᵣₒₗₗ, which may be determined via equation 3 above. The rolling resistance force Fᵣₒₗₗ is dependent on a rolling resistance coefficient fᵣₒₗₗ. The force F_{climb} is dependent on a roadway inclination α_{road}. The roadway inclination α_{road} is assumed to be constant and thus unchanged for at least two successive points in time ti, ti+1, if i equations are set up at different points in time ti and the road inclination α_{road} changes continuously at successive points in time ti, ti+1. The force F_{climb}, and/or the roadway inclination α_{road} may be determined via a sensor or geographic data provided via a navigation system.

In one example, the algorithm may estimate unknown parameters of the road load (equation 3). Unknown parameters may include m, fᵣₒₗₗ, c_{w}*A, α, and v_{wind}. The parameter m may be equal to the total mass of the vehicle including a payload. The parameter fᵣₒₗₗ may be equal to a rolling resistance coefficient. The parameter c_{w}*A may be equal to an air drag coefficient*a vehicle frontal area. The parameter a may be equal to a road gradient. The parameter v_{wind} may be equal to a wind speed in direction parallel to a long axis of the vehicle.

The rolling resistance coefficient may be solved based on equation 5 below.

$${F}_{roll} = m \times g \times {f}_{roll} \times cos α \qquad ( 5 )$$

The air force resistance, Fₐᵢᵣ, of equation 4 may be used in equation 6 below to determine c_{w}*A.

$${F}_{air} = \frac{1}{2} {c}_{w} \times A \times {ρ}_{air} \times {v}^{2} \qquad ( 6 )$$

In one example, wind is ignored in the equation 6. However, wind may be considered in the equation 7 below.

$${F}_{air} = \frac{1}{2} {c}_{w} \times A \times {ρ}_{air} \times {( v + {v}_{wind} )}^{2} \qquad ( 7 )$$

The road gradient α may be determined via equation 8 below.

$${F}_{climb} = m \times g \times sin α \qquad ( 8 )$$

In one example, if a roof box is arranged on the vehicle, then a value of c_{w}*A may increase. As another example, low tire pressures and/or wet roads may increase a value of fᵣₒₗₗ.

At 414, the method 400 may include calculating a vehicle road load. The vehicle road load may be calculated by solving for P_{roadload} in equation 1.

At 416, the method 400 may include predicting energy consumption. The energy consumption may be predicted based on the vehicle road load. For example, as the vehicle road load increases, the energy consumption increases. If the energy consumption increases, then a remaining distance of the vehicle may be reduced. Alternatively, if the energy consumption decreases due to the vehicle road load decreasing, then the remaining distance of the vehicle may increase.

In one example, the method for executing the road load estimator configured to ascertain a functional relationship between the driving resistance and the velocity vᵥₑₕ of a motor vehicle comprising an electrical machine as a torque source for the drive of the motor vehicle and a storage device for electrical energy may include an equation having n unknowns and m available knowns is used for the driving resistance. During operation of the vehicle, i equations, where i≥n, are set up at different times t, for which the m available knowns are provided, so that a not underdetermined equation system having i equations is provided. Via the equation system of the road load estimator, the functional relationship between the driving resistance and the velocity vᵥₑₕ of the motor vehicle may be ascertained. the functional relationship between the driving resistance power P_{road-load} and the velocity vᵥₑₕ of the motor vehicle is ascertained, wherein P_{road-load}. is based on equation 1 above.

At 418, the method 400 may include determining if the current predicted energy consumption is equal to the previous predicted energy consumption. If the current predicted energy consumption and the previous predicted energy consumption are equal, then at 420, the method 400 may include maintaining current operating parameters and continues to execute the road load estimator.

If the currently predicted energy consumption and the previous predicted energy consumption are not equal, then at 422, the method 400 may include adjusting operating parameters based on the predicted energy consumption. As one example, if the currently predicted energy consumption is less than the previously predicted energy consumption, then a remaining distance of the vehicle may be reduced. In one example, a travel plan may be adjusted. For example, other routes to a desired destination may be presented based on the remaining distance. Additionally or alternatively, charging stations may be displayed to the vehicle operator based on the remaining distance. The charging stations may be displayed to an infotainment system or a mobile device such as a smartphone, a laptop, and/or a tablet. In some examples, additionally or alternatively, one or more tips with regard to vehicle operator adjustments may be provided to increase the current predicted energy consumption. The tips may include reduced driving speeds, less aggressive tip-ins, reduced cabin cooling or heating, unplugging one or more devices, and the like.

As another example, if the current predicted energy consumption is greater than the previously predicted energy consumption, then a remaining distance of the vehicle may be increased. In one example, a travel plan may be adjusted. For example, a previously selected charging station may be avoided or switched to another charging station based on vehicle operator selections in response to the increased remaining distance. Additionally or alternatively, cabin climate control may be enhanced, one or more auxiliary devices may be plugged into the vehicle, and power output and/or responsiveness may increase.

In one example, additionally or alternatively, the ascertained functional relationship between the driving resistance and the velocity vᵥₑₕ of the motor vehicle is used to estimate the need for electrical energy for a predefined travel route. The electrical energy is compared to the electrical energy available in the energy storage device. If the electrical energy is different than the electrical energy available in the energy storage device, then the travel plan may be adjusted as described above.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
determining a vehicle road load based on a relationship between a driving resistance and a vehicle velocity;
determining an energy consumption based on the vehicle road load; and
comparing the energy consumption to energy available in an energy storage device.

2. The method of claim 1, wherein the energy storage device is a battery and the energy consumption is electrical energy consumption, the method further comprising adjusting a travel plan in response to the comparison.

3. The method of claim 1, wherein the vehicle road load is based on a drive power of an electric motor, a mass of the vehicle, and an acceleration of a vehicle.

4. The method of claim 3, wherein the vehicle road load is further based on a driving resistance force.

5. The method of claim 4, wherein the driving resistance force is based on a rolling resistance force, an air resistance force, and a slope force acting on the vehicle.

6. The method of claim 5, wherein the air resistance force is dependent on an air resistance coefficient and an area of the vehicle perpendicular to a velocity of the vehicle.

7. The method of claim 1, wherein determining the vehicle road load based on the relationship between the driving resistance and the vehicle velocity further comprises an equation system comprising a plurality of unknowns, wherein the plurality of unknowns comprises a mass of the vehicle, a rolling resistance, a rolling resistance coefficient, an air resistance force, an air resistance coefficient, an area of the vehicle, and a roadway inclination.

8. The method of claim 7, wherein the equation system further comprises a plurality of knowns comprising a drive power of an electric motor, a velocity of the vehicle, and an acceleration of the vehicle.

9. The method of claim 7, wherein a number of equations executed by the equation system is greater than a number of the plurality of unknowns.

10. A system, comprising:
a vehicle comprising a motor and an energy storage device; and
a controller comprising computer-readable instructions stored on non-transitory memory thereof that cause the controller to:
adjust a travel plan in response to a comparison of energy needed for the travel plan to energy available in the energy storage device, wherein the energy needed is determined based on a vehicle road load is based on a drive power of an electric motor, a mass of the vehicle, and an acceleration of the vehicle.

11. The system of claim 10, wherein the vehicle road load is further based on an air resistance force, and wherein the air resistance force is based on an air resistance coefficient and an area of the vehicle perpendicular to a velocity of the vehicle.

12. The system of claim 10, wherein known values for determining the vehicle road load comprise a drive power of the motor and a velocity of the vehicle.

13. The system of claim 10, wherein the instructions further enable the controller to adjust the travel plan to route to a charging station closer to the vehicle than previously routed in response to the energy needed for the travel plan being less than the energy available in the energy storage device.

14. The system of claim 10, wherein the instructions further enable the controller to adjust the travel plan to route to a charging station farther from the vehicle than previously routed in response to the energy needed for the travel plan being greater than the energy available in the energy storage device.

15. The system of claim 10, wherein the vehicle road load is further based on a roadway slope, and wherein the roadway slope is assumed to be constant for at least two successive points in time tᵢ, tᵢ₊₁, if I equations are set up at different point in time tᵢ and the roadway slope changes continuously at successive point in tᵢ, tᵢ₊₁.

16. A method, comprising:
estimating an energy consumption of a travel plan of a vehicle based on a relationship between a driving resistance and a velocity of a vehicle via an equation system having n unknowns and m available knowns is used for the driving resistance, wherein during operation of the vehicle the equation system comprises i equations, where i≥n, are set up at different times t, for which the m available knowns are provided, so that a not underdetermined equation system having i equations is provided.

17. The method of claim 16, wherein the energy consumption is further based on a drive power of one or more of an electric motor and an engine, a mass of the vehicle, an acceleration of the vehicle, a driving resistance power, a driving resistance force, a rolling resistance force, an air resistance force, and a roadway slope.

18. The method of claim 17, wherein the air resistance force is based on an air resistance coefficient and an area of the vehicle perpendicular to the velocity of the vehicle, and wherein a vehicle mass is estimated based on the drive power of one or more of the electric motor and the engine, the acceleration of the vehicle, the velocity of the vehicle, and the driving resistance power, and wherein the driving resistance power is based on a rolling resistance force Fᵣₒₗₗ.

19. The method of claim 16, further comprising adjusting the travel plan in response to the energy consumption being different than an amount of energy stored in the energy storage device or maintaining the travel plan in response to the energy consumption being equal to an amount of energy stored in the energy storage device.

20. The method of claim 16, further comprising determining one or more unknown parameters including a rolling resistance coefficient and an air resistance coefficient and an area of the vehicle perpendicular to a velocity of the vehicle based on a driving resistance.
